(19) United States
(12) Patent Application Publication
(10) Pub. No.: US 2014/0164666 A1
(43) Pub. Date: Jun. 12, 2014

(54) SERVER AND METHOD FOR SHARING PERIPHERAL COMPONENT INTERCONNECT EXPRESS INTERFACE

(71) Applicant: HON HAI PRECISION INDUSTRY CO., LTD., New Taipei (TW)

(72) Inventor: JIA-RU YANG, New Taipei (TW)

(73) Assignee: HON HAI PRECISION INDUSTRY CO., LTD., New Taipei (TW)

(21) Appl. No.: 13/900,583

(22) Filed: May 23, 2013

(30) Foreign Application Priority Data
Dec. 7, 2012 (TW) 101146281

(51) Int. Cl. G06F 13/28

(52) U.S. Cl. CPC G06F 13/28
USPC 710/308

(57) ABSTRACT

A server provides a sharing method for a peripheral component interconnect express (PCIe) interface to one or more servers. The server receives an accessing request from a virtual machine to access a sharing unit, and transmits a model number of the sharing unit with the PCIe interface and a memory address of a PCIe base address register (BAR). The server establishes a first window in a storage device of the virtual machine, and maps the first window to a memory of the PCIe BAR of the sharing unit. The server further establishes a second window in a storage device of the server, and maps the second window to the storage device of the virtual machine.

### BACKGROUND

1. Technical Field

This present disclosure is related to a hardware sharing method, and is particularly related to a server and a method for sharing a peripheral component interconnect express interface.

2. Description of Related Art

An input/output unit can be shared with a plurality of servers, but a driver of the input/output unit is modified in a server when the server shares the input/output unit with another server. For example, when a server transmits data using a network interface card (NIC) of another server, the server uses a particular driver. The driver of the server is modified according to loading different types of the NIC, and the NIC can be shared, but usage efficiency of the NIC is inefficient. When the server does not modify the driver, only the NIC corresponding to the particular driver can be shared. The type of the NIC that can be loaded is limited, and sharing efficiency of the servers is adversely affected.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic diagram of an embodiment of a server having units that can be shared with the other server via a peripheral component interconnect express (PCIe) interface.

FIG. 2 is a functional module diagram of an embodiment of a sharing system having a PCIe interface.

FIG. 3 is a flowchart of an embodiment of a sharing method of a PCIe interface.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

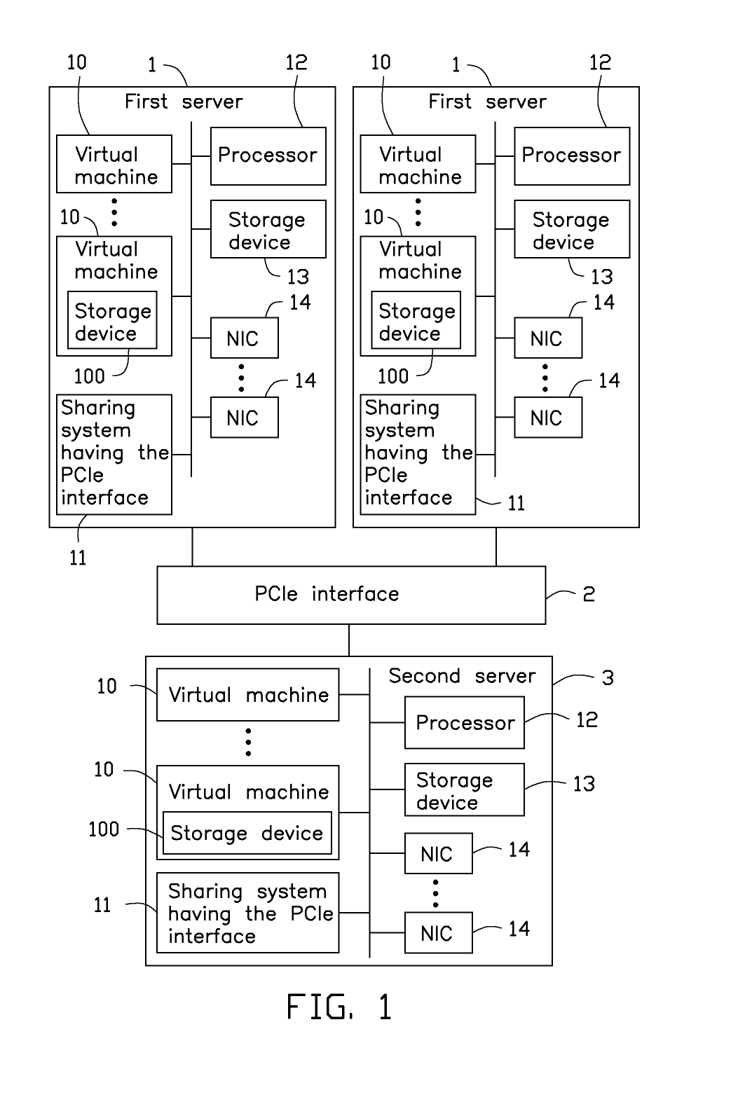

FIG. 1 is a schematic diagram of an embodiment of a server having units that can be shared with the other server via a peripheral component interconnect express (PCIe) interface 2. In the embodiment, the unit has a PCIe interface and can be shared via the PCIe interface 2. The server includes a sharing system 11 for sharing the unit, such as a network interface card (NIC) having the PCIe interface, for example, of the other server via the PCIe interface 2. In other words, the unit is a sharing unit.

In the embodiment, the network interface card (NIC) having the PCIe interface is the sharing unit, for example. In the instant application, the sharing unit may be a serial attached SCSI (SAS) card, or host bus adapter (HBA) card, for example. The SCSI is a small computer system interface.

For easily understanding of the follow description, the servers are separated into different groups, such as a group of a plurality of first servers 1, and another group of a second server 3 (shown in FIG. 1), for example. The first server 1 can use the sharing unit of the second server 3. The second server 3 provides a plurality of NICs 14, and the first server 1 can use the NICs 14 via the PCIe interface 2. The number of first servers 1, the number of second servers 3, and the number of NICs 14 which are shown in FIG. 1 are examples, and the numbers are not limited in the instant application.

The first server 1 includes a plurality of virtual machines 10, a processor 12, a storage device 13, and other software or hardware devices that are not shown, such as input/output devices, for example. Each virtual machine 10 includes a storage device 100 for storing data of the virtual machine 10, such as text files and images, for example.

The processor 12 can execute the sharing system 11 and software installed in the first server 1, such as an operating system, for example.

In the embodiment, the first server 1 is connected with the second server 3 via the PCIe interface 2. In another embodiment, the first server 1 may be connected with the second server 3 via another interface, such as a peripheral component interconnect (PCI) interface, for example.

The sharing system 11 is also installed in the second server 3 that includes a plurality of NICs 14, a processor 12, and a storage device 13. The processor 12 executes the sharing system 11 and the software installed in the second server 3, such as an operating system, for example. The storage device 13 stores data of the second server 3, such as data received and installed by the sharing system 11.

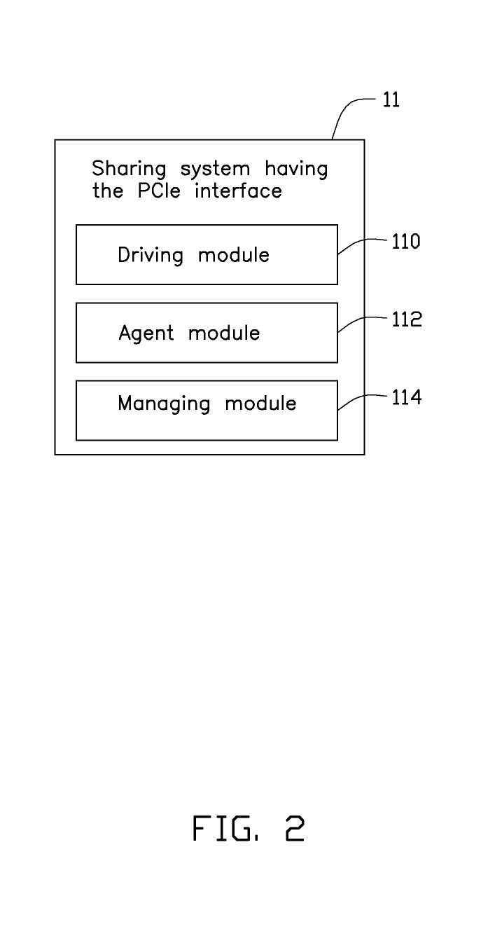

FIG. 2 is a functional module diagram of the embodiment of the sharing system 11. The sharing system 11 includes a driving module 110, an agent module 112, and a managing module 114.

The virtual machine 10 of the first server 1 determines a model number of a NIC 14 of the second server 3 for the purpose of loading a correct driver of the NIC 14. The virtual machine 10 accesses the PCIe configured space of the NIC 14, where the PCIe configured space saves the model number of the NIC 14.

The driving module 110 receives an accessing request from the virtual machine 10 to access PCIe configured space of the NIC 14 of the second server 3, and transmits the accessing request to the agent module 112. The accessing request is configured to receive the model number of the NIC 14.

The driving module 110 transmits the accessing request to the agent module 112 using a netlink. The netlink is a particular inter-process communication (IPC) between a kernel process and a user space process, and is a common interface for communicating with a network application program and a kernel.

The agent module 112 transmits the accessing request to the managing module 114. For example, the agent module 112 can transmit the accessing request to the managing module 114 according to the IPC.

The managing module 114 receives the accessing request and loads the model number of the NIC 14 from the PCIe configured space of the NIC 14 according to the accessing request.

The managing module 114 further transmits the model number of the NIC 14 and a memory address of a PCIe base address register (BAR) of the NIC 14 to the agent module 112.

The agent module 112 further transmits the model number of the NIC 14 to the virtual machine 10. The virtual machine 10 can determine a correct driver of the NIC 14 from an operating system of the first server 1 according to the model number of the NIC 14, and the virtual machine 10 can thus transmit data using the NIC 14.

The driving module 110 establishes a first window in the storage device 100 of the virtual machine 10. For example, the driving module 110 can assign storage space according to the memory address of the PCIe BAR. The first window is a window corresponding to the PCIe BAR.

The driving module 110 maps the first window to a memory of the PCIe BAR of the NIC 14 according to the memory address of the PCIe BAR. A mapping of the first window and the PCIe BAR is implemented for ease of loading the first window when the virtual machine 10 accesses the PCIe BAR of the NIC 14.

For example, the agent module 112 converts a first window command for accessing the storage device 100 of the virtual machine 10 into a command for accessing the memory of the PCIe BAR of the NIC 14 when the virtual machine 10 accesses the PCIe BAR using the first window, and executes the command for accessing the memory of the PCIe BAR.

The managing module 114 further establishes a second window in the storage device 13 of the second server 3, and maps the second window to the storage device 100 of the virtual machine 10.

The managing module 114 executes an address translation of a direct memory access (DMA) command of the NIC 14 using input/output memory management units (IOMMU).

The managing module 114 converts the DMA command of the NIC 14 into a DMA command for accessing the second window using the IOMMU when the NIC 14 accesses the storage device 100 of the virtual machine 10. The managing module 114 converts the DMA command for accessing the second window into a command for accessing the storage device 100 of the virtual machine 10 using the IOMMU, and executes the command for accessing the storage device 100 of the virtual machine 10.

The first window and the second window are established using a PCIe non-transparent bridge (NTB), and a mapping of the first window and a mapping of the second window are implemented by the IOMMU.

In another embodiment, when the second server 3 includes a plurality of NICs 14, the managing module 114 separates each NIC 14 to each virtual machine 10, and executes functions of the driving module 110, the agent module 112, and the managing module 114 to implement a sharing of the NIC 14 of the second server 3.

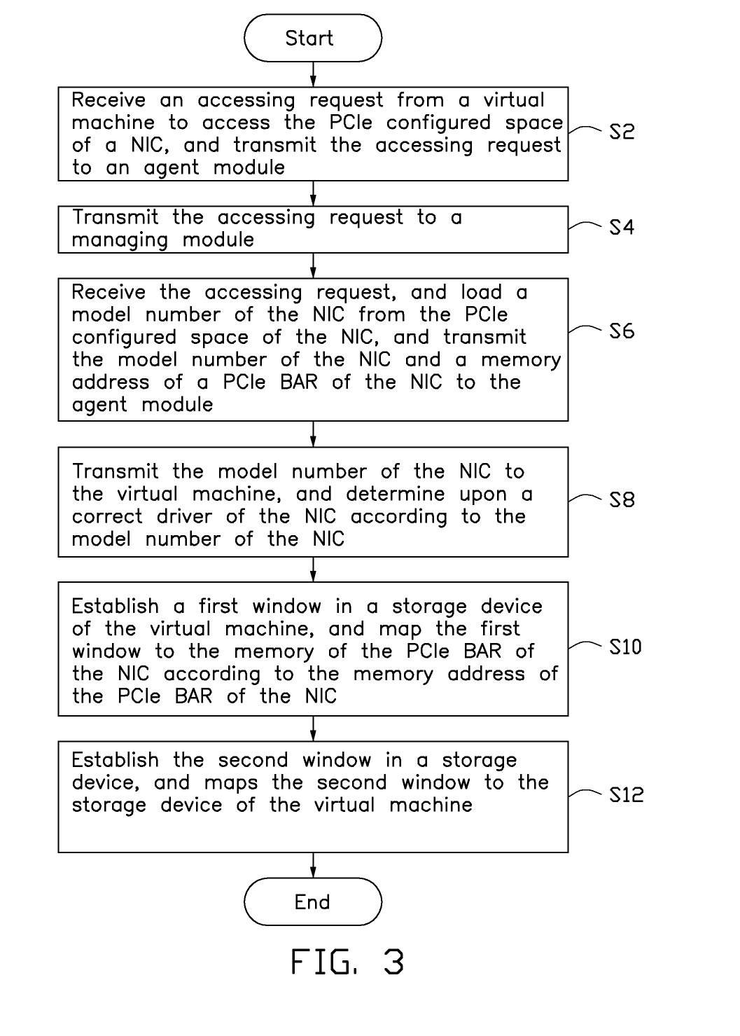

FIG. 3 is a flowchart of an embodiment of a sharing method of a PCIe interface. In step S2, the driving module 110 receives an accessing request from the virtual machine 10 to access the PCIe configured space of the NIC 14 of the second server 3, and transmits the accessing request to the agent module 112. The accessing request is used for receiving the model number of the NIC 14, and then step S4 is implemented.

In step S4, the agent module 112 transmits the accessing request to the managing module 114 of the second server 3, and then step S6 is implemented.

In step S6, the managing module 114 receives the accessing request, and loads the model number of the NIC 14 from the PCIe configured space of the NIC 14, and transmits the model number of the NIC 14 and the memory address of the PCIe BAR of the NIC 14 to the agent module 112, and then step S8 is implemented.

In step S8, the agent module 112 transmits the model number of the NIC 14 to the virtual machine 10. The virtual machine 10 determines upon the correct driver of the NIC 14 from the operating system of the first server 1 according to the model number of the NIC 14, and then step S10 is implemented.

In step S10, the driving module 110 establishes the first window in the storage device 100 of the virtual machine 10, and maps the first window to the memory of the PCIe BAR of the NIC 14 according to the memory address of the PCIe BAR of the NIC 14, and then step S12 is implemented.

In step S12, the managing module 114 establishes the second window in the storage device 13 of the second server 3, and maps the second window to the storage device 100 of the virtual machine 10, to end the flowchart.

Depending on the embodiment, certain of the steps described may be removed, others may be added, and the sequence of the steps may be altered. It is also to be understood that the description and the claims drawn to a method may include some indication in reference to certain steps. However, the indication used is only to be viewed for identifying purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. A server, comprising:
at least one virtual machine;
at least one sharing unit;
a storage device;
at least one processor; and
one or more modules stored in the storage device and executed by the at least one processor, the one or more modules comprising:
a driving module configured to determine a model number of a sharing unit having a peripheral component interconnect express (PCIe) interface by receiving an accessing request from the virtual machine to access PCIe configured space of the sharing unit, and transmit the accessing request to an agent module; the driving module establishing a first window in a storage device of the virtual machine, and mapping the first window to a memory of a PCIe base address register (BAR) according to a memory address of the PCIe BAR of the sharing unit;
wherein the agent module transmits the accessing request to a managing module, and transmits the model number of the sharing unit to the virtual machine, and transmits the model number of the sharing unit to the virtual machine;
wherein the managing module receives the accessing request, and transmits the model number of the sharing unit and a memory address of the PCIe BAR to the agent module, and establishes a second window in the storage device, and maps the second window to the storage device of the virtual machine; and
wherein the virtual machine determines a driver of the sharing unit according to the model number of the sharing unit.

2. The server of claim 1, wherein the agent module converts a command for accessing the storage device of the virtual machine into a command for accessing the memory of the PCIe BAR when the virtual machine executes an access using the first window, and executes the command for accessing the memory of the PCIe BAR.

3. The server of claim 2, wherein the managing module further executes an address translation of a direct memory access (DMA) command of the sharing unit using input/output memory management units (IOMMU) of the server.

4. The server of claim 3, wherein the managing module further converts the DMA command of the sharing unit into a DMA command for accessing the second window using the IOMMU when the sharing unit accesses the storage device of the virtual machine, and converts the DMA command for accessing the second window into the command for accessing the storage device of the virtual machine using the IOMMU, and executes the command for accessing the storage device of the virtual machine.

5. The server of claim 1, wherein the first window and the second window are established using a PCIe non-transparent bridge (NTB), and the first window and the second window are mapped by the IOMMUs.

6. A sharing method of a peripheral component interconnect express (PCIe) interface, the sharing method being executed by a server, the sharing method comprising:
determining a model number of a sharing unit by receiving an accessing request from a virtual machine to access PCIe configured space;
transmitting the model number of the sharing unit and a memory address of a PCIe base address register (BAR) of the sharing unit;
transmitting the model number of the sharing unit to the virtual machine, and determining a driver of the sharing unit according to the model number of the sharing unit;
establishing a first window in a storage device of the virtual machine, and mapping the first window to a memory of the PCIe BAR of the sharing unit according to a memory address of the PCIe BAR of the sharing unit; and
establishing a second window in a storage device of the server, and mapping the second window to the storage device of the virtual machine.

7. The sharing method of claim 6, further comprising:
converting a command for accessing the storage device of the virtual machine into a command for accessing the memory of the PCIe BAR of the sharing unit when the virtual machine executes an access using the first window; and
executing the command for accessing the memory of the PCIe BAR of the sharing unit.

8. The sharing method of claim 6, further comprising:
executing an address translation of a direct memory access (DMA) command of sharing unit using input/output memory management units (IOMMU) of the server.

9. The sharing method of claim 8, further comprising:
converting the DMA command of the sharing unit into a DMA command of the second window using the IOMMU when the sharing unit accesses the storage device of the virtual machine; and
converting the DMA command of the second window into the command for accessing the storage device of the virtual machine using the IOMMU, and executing the command for accessing the storage device of the virtual machine.

10. The sharing method of claim 6, wherein the first window and the second window are established using a PCIe non-transparent bridge (NTB), and the first window and the second window are mapped by the IOMMUs.

11. A non-transitory computer-readable storage medium having stored thereon instructions that, when executed by at least one processor of a server, causes the processor to perform a sharing method, the sharing method comprising:
determining a model number of a sharing unit by receiving an accessing request from a virtual machine to access a peripheral component interconnect express (PCIe) configured space;
transmitting the model number of the sharing unit and a memory address of a PCIe base address register (BAR) of the sharing unit;
transmitting the model number of the sharing unit to the virtual machine, and determining a driver of the sharing unit according to the model number of the sharing unit;
establishing a first window in a storage device of the virtual machine, and mapping the first window to a memory of the PCIe BAR of the sharing unit according to a memory address of the PCIe BAR of the sharing unit; and
establishing a second window in a storage device of the server, and mapping the second window to the storage device of the virtual machine.

12. The storage medium of claim 11, wherein the sharing method further comprises:
converting a command for accessing the storage device of the virtual machine into a command for accessing the memory of the PCIe BAR of the sharing unit when the virtual machine executes an access using the first window; and
executing the command for accessing the memory of the PCIe BAR of the sharing unit.

13. The storage medium of claim 11, wherein the sharing method further comprises:
executing an address translation of a direct memory access (DMA) command of the sharing unit using input/output memory management units (IOMMU) of the server.

14. The storage medium of claim 13, wherein the sharing method further comprises:
converting the DMA command of the sharing unit into a DMA command of the second window using the IOMMU when the sharing unit accesses the storage device of the virtual machine; and
converting the DMA command of the second window into the command for accessing the storage device of the virtual machine using the IOMMU, and executing the command for accessing the storage device of the virtual machine.

15. The storage medium of claim 11, wherein the first window and the second window are established using a PCIe non-transparent bridge(NTB), and the first window and the second window are mapped by the IOMMUs.
